(19) United States
(12) Patent Application Publication
(10) Pub. No.: US 2026/0351622 A1
(43) Pub. Date: Nov. 5, 2026

(54) BATTERY

(71) Applicant: ETERNITY TECHNOLOGIES LIMITED, Manchester (GB)

(72) Inventor: James Mark Stevenson, Manchester (GB)

(21) Appl. No.: 19/118,236

(22) PCT Filed: Oct. 4, 2023
(86) PCT No.: PCT/EP23/77400

§ 371 Date: Apr. 3, 2025

(30) Foreign Application Priority Data
Oct. 4, 2022 (GB) 2214608.8

(51) Int. Cl. H01M 4/73; B60L 50/64; H01M 4/14; H01M 4/583; H01M 10/10; H01M 50/414; H01M 50/491; H01M 50/51

(52) U.S. Cl. CPC H01M 4/73; H01M 4/14; H01M 4/583; H01M 10/10; H01M 50/414; H01M 50/491; H01M 50/51; B60L 50/64; H01M 2220/20; H01M 2300/0085

(57) ABSTRACT

A gelled lead acid battery comprising at least one positive electrode, at least one negative electrode, and an electrolyte including a gelling agent, wherein the at least one positive electrode includes a plurality of tube members each comprising a tube containing positive active material (PAM) and a conducting spine in contact with the positive active material, and wherein the at least one negative electrode comprises a conducting grid and a negative active material (NAM) in contact with the conducting grid, which negative active material comprises carbon nanomaterial.

### TECHNICAL FIELD

This invention relates to a lead acid battery, a battery assembly comprising multiple lead acid batteries, and uses of the lead acid battery or the battery assembly.

### BACKGROUND

Lead acid batteries have been used for over 150 years. Current lead acid batteries typically comprise positive and negative electrode plates separated by microporous separators. The electrolyte includes an aqueous acid solution, most commonly sulfuric acid (H₂SO₄).

An early gelled lead acid battery developed in the 1950s by Sonnenschein (Germany) became popular in the 1970s. Mixing sulfuric acid with a silica-gelling agent converts liquid electrolyte into a semi-stiff paste to reduce or eliminate maintenance of the electrolyte.

A valve regulated lead-acid (VRLA) battery, commonly known as a sealed lead-acid (SLA) battery, is a type of lead-acid battery characterized by a electrolyte formed into a gel and/or absorbed in a plate separator; proportioning of the negative and positive plates so that oxygen recombination is facilitated within the cell; and the presence of a relief valve that retains the battery contents independent of the position of the cells.

In any lead acid battery, the manufacture of positive and negative electrodes commonly involves producing a positive active material (PAM) and a negative active material (NAM). The PAM and NAM are prepared as pastes, which generally comprise lead (II) oxide (PbO). The positive and negative active material pastes are applied to conducting structures such as electrode grids, and then cured to provide the positive and negative electrodes. Electrode grids are generally primarily constructed of lead, but can be alloyed with antimony, calcium and/or tin.

After curing, the positive and negative electrodes are assembled into a precursor battery, which undergoes a step known as “formation”. During the formation step, aqueous sulfuric acid is added and a charge is applied to the battery in order to convert the lead (II) oxide of the positive plates to lead dioxide (PbO₂, also known as lead (IV) oxide) and the lead (II) oxide of the negative plates to lead (Pb). Formation may occur with circulating acid, which helps to control heat generation during the formation process.

In a gelled lead acid battery, an electrolyte including a gelling agent may be introduced after formation.

Lead acid batteries may be discharged and charged for numerous cycles. During discharge, the PAM and NAM react with the sulfuric acid of the electrolyte to form lead (II) sulfate (PbSO₄). The charging and discharging reactions for the positive and negative electrodes may be represented by the following formulae:

### Negative Electrode:

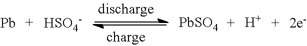

### Positive Electrode:

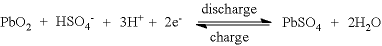

Various types of lead acid batteries are known. For example, lead acid batteries are most commonly used in motor vehicles as “SLI batteries”, with SLI standing for starting, lighting and ignition. These batteries are designed to deliver maximum current for a short period of time, but are not designed for deep discharging; a full discharge can reduce the lifespan of these batteries. Lead acid batteries are also used in stationary applications, for example providing an uninterruptible power supply in power plants and data centres.

Lead acid batteries can also be used to produce motion, and play a key role in industrial electric vehicles, such as forklift trucks. Applications where the battery energy is used to produce motion are known as motive power applications, and batteries used to provide energy for motion are known as motive power batteries or traction batteries.

Industrial motive power applications can be very demanding on batteries, for example in large storage warehouses where forklift trucks may be running non-stop for a full shift and also lifting objects to great heights. Such batteries are generally operated in a Partial State of Charge regime, i.e. cycling below the fully charged state during most of the operation time. These heavy-duty applications require batteries with long runtimes, fast charging and discharging, and high current bursts, which in existing batteries can cause severe reduction to battery life.

There are particular form-factors associated with motive power applications, such as the PzS standard defined in DIN/EN 60254-2. Such form factors place constraints on battery dimensions and, by extension, also on battery design.

A need remains for lead acid batteries with improved performance, such as higher capacities, shorter charging times, longer runtimes, improved high bursts of current, longer battery life and/or greater convenience.

### SUMMARY OF THE INVENTION

It has now been found that the capacity and charging speed of a lead acid battery can be improved with a combination of a positive electrode comprising tube members and a negative electrode comprising negative active material including carbon nanomaterial.

One aspect of the invention provides a gelled lead acid battery comprising at least one positive electrode, at least one negative electrode, and an electrolyte including a gelling agent, wherein the at least one positive electrode includes a plurality of tube members each comprising a tube containing positive active material (PAM) and a conducting spine in contact with the positive active material, and wherein the at least one negative electrode comprises a conducting grid and a negative active material (NAM) in contact with the conducting grid, which negative active material comprises carbon nanomaterial.

It has been found that a positive electrode comprising tube members can unlock performance gains from a negative electrode comprising carbon nanomaterial, and vice versa. This can facilitate improved performance for the battery as a whole.

The tube members may in principle have any dimension suitable for the battery. However, it has been found that a smaller cross-sectional diameter of the tube members of the positive electrode can enable enhanced performance, particularly in a battery comprising a negative electrode comprising negative active material including carbon nanomaterial. A reduction in the cross-sectional diameter of the tube members can improve utilisation and packing of the positive active material and reduce electrical resistance at higher rates of discharge. This is of particular advantage in the context of a performant negative electrode.

In this context, a further aspect of the invention provides a gelled lead acid battery comprising at least one positive electrode, at least one negative electrode, and an electrolyte including a gelling agent, wherein the at least one positive electrode includes a plurality of tube members each comprising a tube containing positive active material (PAM) and a conducting spine in contact with the positive active material wherein the conducting spines of the tube members have a cross section with a largest diameter of 3.5 mm or less and the positive electrode has a thickness of 9.5 mm or less, and wherein the at least one negative electrode comprises a conducting grid and a negative active material (NAM) in contact with the conducting grid, which negative active material comprises carbon nanomaterial.

Optional features of both aforementioned aspects of the invention are set out hereinbelow, including in the dependent claims.

The positive electrode comprises a plurality of tube members comprising a tube containing positive active material (PAM) and a conducting spine in contact with the positive active material. Such an electrode may be referred to as a “tubular plate” electrode.

Advantageously, the plurality of tube members may be arranged adjacently in a substantially parallel fashion.

The number of tube members in the positive electrode depends on the dimensions of the electrode and the tube members. Suitably, the positive electrode may comprise in the range of from 15 to 30 tube members, for example from 15, from 16, from 17, from 18, from 19, from 20, from 21, from 22, from 23, or from 24 tube members, and/or up to 30, up to 29, up to 28, up to 27, up to 26, up to 25, or up to 24 tube members.

Preferably, the tube members of the positive electrode may consist of the plurality of tube members, with no other tube members being present.

Conveniently, the tube members may have one or more substantially identical properties, or indeed may be substantially identical. This leads to manufacturing efficiencies and facilitates consistency within the battery.

The cross-sectional diameter of the tube members should be sufficiently great to ensure structural integrity. Efficiency of manufacture may also be a consideration.

In various embodiments, the tube members may have a cross section with a largest diameter of 9.5 mm or less, 9.0 mm or less, 8.5 mm or less, 8.0 mm or less, 7.9 mm or less, 7.8 mm or less, 7.7 mm or less, or 7.6 mm or less. Suitably, the tubes may have a cross section with a largest diameter of 3.5 mm or more, 4.0 mm or more, 4.5 mm or more, 5.0 mm or more, 5.5 mm or more, 6.0 mm or more, 6.5 mm or more, 7.0 mm or more, or 7.5 mm or more. Preferably, the tube members may have a cross section with a largest diameter of 8.0 mm or less, or from 7.0 to 8.0 mm, for example from 7.5 to 7.7 mm, or about 7.6 mm.

Additionally or alternatively, a mean of the largest cross-sectional diameters of the tube members may fall within one or more of the thresholds in the preceding paragraph.

The length of the tube members may be determined by the height and desired capacity of the battery. Suitably, the tube members may have a length of at least 100 mm, at least 150 mm, at least 200 mm, at least 250 mm, at least 300 mm, at least 310 mm, at least 320 mm, at least 330 mm, or at least 340 mm; and/or up to 1000 mm, up to 900 mm, up to 800 mm, up to 750 mm, up to 700 mm, up to 650 mm, or up to 600 mm.

The plurality of tube members each comprise a conducting spine.

As aforesaid, in principle, the tube members need not be identical and this also applies to the conductive spines of the tube members. That said, substantially identical spine members can offer convenience and consistency.

To facilitate a smaller cross-sectional diameter of the tube members, a smaller cross-sectional diameter of the spines may be of advantage. On the other hand, again this must be balanced with structural integrity.

In an embodiment, the conducting spines in the one or more tube members may each have a cross section with a largest diameter of 3.5 mm or less, such as 3.4 mm or less, 3.3 mm or less, 3.2 mm or less, 3.1 mm or less, 3.0 mm or less, or 2.9 mm or less. Suitably, the conducting spines may each have a cross section with a largest diameter of 2.0 mm or more, 2.1 mm or more, 2.2 mm or more, 2.3 mm or more, 2.4 mm or more, 2.5 mm or more, 2.6 mm or more, 2.7 mm or more, or 2.8 mm or more. Preferably, the conducting spines may each have a cross section with a largest diameter of 3.0 mm or less. More preferably, the conducting spines may each have a cross section with a largest diameter of from 2.8 to 3.0 mm.

Additionally or alternatively, a mean of the largest cross-sectional diameters of the spines may fall within one or more of the thresholds in the preceding paragraph.

Various shapes are possible for the cross section of the spines in the tube members. The cross sections may for example be of circular, elliptical, oval, rectangular or square shape. Suitably, the conducting spines may have an elliptical cross section. An elliptical cross section has a largest diameter, which is the distance across the widest part of the ellipse (also referred to as the major axis); and a smallest diameter, which is the distance across the smallest part of the ellipse (also referred to as the minor axis). An elliptical cross-section can offer up more surface area and may be aligned such that the smallest diameter defines a reduced thickness of the spines, which may in turn contribute to a reduced thickness of the electrode as a whole. Furthermore, such a cross-section can facilitate the formation of the spines, e.g. by casting, by improving strength.

Optionally, the conducting spines may have an elliptical cross section with a largest diameter of 3.5 mm or less, such as 3.4 mm or less, 3.3 mm or less, 3.2 mm or less, 3.1 mm or less, 3.0 mm or less, or 2.9 mm or less; and/or a smallest diameter of 3.0 mm or less, such as 2.9 mm or less, 2.8 mm or less, 2.7 mm or less, or 2.6 mm or less. Preferably, the conducting spines may have an elliptical cross section with a largest diameter of 3.0 mm or less, and a smallest diameter of 2.7 mm or less.

Suitably, the conducting spines may have an elliptical cross section with, for example, a largest diameter of 2.0 mm or more, 2.1 mm or more, 2.2 mm or more, 2.3 mm or more, 2.4 mm or more, 2.5 mm or more, 2.6 mm or more, 2.7 mm or more, or 2.8 mm or more; and/or a smallest diameter of 2.0 mm or more, or 2.1 mm or more, 2.2 mm or more, 2.3 mm or more, 2.4 mm or more, or 2.5 mm or more. Preferably, the conducting spines may have an elliptical cross section with a largest diameter of from 2.8 to 3.0 mm, and a smallest diameter of from 2.5 to 2.7 mm, such as a largest diameter of about 2.9 mm, and a smallest diameter of about 2.6 mm.

The length of the spines may be determined by the height and desired capacity of the battery. Suitably, the spines may have a length of at least 100 mm, at least 150 mm, at least 200 mm, at least 250 mm, at least 300 mm, at least 310 mm, at least 320 mm, at least 330 mm, or at least 340 mm; and/or up to 1000 mm, up to 900 mm, up to 800 mm, up to 750 mm, up to 720 mm, up to 700 mm, up to 650 mm, or up to 600 mm.

The conducting spines may comprise or consist of a suitably conductive and strong material. Optionally, the spines may comprise or consist of a lead alloy. Conducting spines may for example be made from such an alloy using high pressure die casting.

To aid structural strength, particularly in the context of smaller cross-sectional diameter, the lead alloy may advantageously comprise antimony. Preferably, the conducting spines may be made of a lead antimony alloy. In some embodiments, the spines comprise or consist of lead antimony alloy having at least 3 wt %, or even at least 4 wt % antimony.

To help mitigate hydrogen evolution, the lead alloy may advantageously comprise calcium. Suitably, calcium may be present in the alloy in an amount of at least 0.01 wt %, at least 0.1 wt %, or even at least 0.5 wt %.

Other additives which may be comprised in the lead alloy or lead antimony alloy may for example include tin, aluminium, arsenic, copper, sulfur, selenium, bismuth, iron, manganese, nickel, silver, tellurium, and/or zinc, which for example may each independently be present in amounts of less than 0.5 wt %, or less than 0.3 wt %. Suitably, such additives may be present in an amount of at least 0.01 wt %, at least 0.05 wt %, or even at least 0.1 wt %.

In some embodiments, the lead alloy comprises calcium and tin, optionally in combination with a further additive from the list above.

The tube members each comprise a positive active material. Conveniently, this may be held within a tube of the tube member, for example forming part of a gauntlet.

As aforesaid, in principle, the tube members need not be identical and this also applies to the positive active material. That said, substantially identical positive active material can offer convenience and consistency.

Various types of positive active material for lead acid batteries are known in the art. The positive active material is commonly prepared as a paste, which paste may be cured to form the positive active material. The paste may comprise lead (Pb) and lead (II) oxide (PbO). One of the starting materials for an active material paste is known as “grey oxide” or “grey lead oxide”, which is a mixture of lead (Pb) and lead (II) oxide (PbO), for example in a ratio of about 1:2 Pb:PbO. The positive active material paste may further comprise “red lead” or “red lead oxide”, which is lead (II,IV) oxide (Pb₃O₄).

In an embodiment, the positive active material paste may comprise lead (Pb), lead monoxide (PbO), sulfuric acid (H₂SO₄) and water. In another embodiment, the positive active material paste may comprise lead (Pb), lead monoxide (PbO), red lead oxide (Pb₃O₄), sulfuric acid (H₂SO₄) and water. The lead (Pb) and lead monoxide (PbO) components may together be referred to as “grey lead oxide” (or “grey oxide”) and may be as described above.

When red lead oxide (Pb₃O₄) is present, it may be present in an amount defined relative to the amount of grey lead oxide. For example, the positive active material paste may comprise grey lead oxide and red lead oxide in a ratio grey lead oxide:red lead oxide of from 100:0 to 50:50, for example from 90:10 to 50:50, from 80:20 to 55:45, or from 75:25 to 60:40.

Suitably, the grey lead oxide, or the grey lead oxide and the red lead oxide (when present), may constitute at least 70 wt % of the positive active material paste, such as for example from 70 wt % to 80 wt %, or from 74 wt % to 76 wt %.

A remainder of the positive active material paste may be sulfuric acid and water, as is known in the art.

The components for a positive active material paste may be added to commercial paste mixing machines common in the industry, such as for example a vacuum mixer, to prepare the positive active material paste.

The positive active material paste can be cured to form the positive active material in the positive electrode, as is known in the art.

Positive active material may advantageously be held within a tube defining the dimensions of the tube member, e.g. as hereinabove defined.

A plurality of such tubes may together form a gauntlet. Thus, the tubes of the tube members may together form a gauntlet. The tubes (and thus the tube members) may be connected along their lengths to form a tubular sheath.

The tubes may be made of suitably permeable material which is resistant to acid and to reactions in the battery. Examples include glass and certain polymers.

In some embodiments, the tubes may comprise a fibrous material. Suitably, the fibrous material may be woven or non-woven. The fibrous material may conveniently be polymeric, for example a polyester.

Suitably, the fibrous material may be non-woven with a fabric weight greater than 135 g/m², optionally greater than 140 g/m².

In various embodiments, the tubes comprise a fibrous non-woven polyester.

Suitably, the tube members may be formed by feeding the conducting spines into tubes, and extruding positive active material paste into the tubes around the spines. The tubes may be filled so that each spine is surrounded by active material paste. The positive active material paste in the assembled positive tubular plate is cured to form the positive active material. An optional drying step may occur before curing.

A bottom end of the conducting spines of the tube members may be connected by a bottom bar. A top end of conducting spines of the tube members may be connected to a positive group bar, which may be further connected to a positive pillar.

A thickness of the positive electrode may be defined by the thickness of the tube members. A reduction in the cross-sectional diameter of the tube members can reduce the thickness of the positive electrode, which reduces resistance and may permit the incorporation of additional electrodes in a given form factor.

Suitably, the positive electrode may have a thickness of 9.5 mm or less, 9.0 mm or less, 8.5 mm or less, 8.0 mm or less, 7.9 mm or less, 7.8 mm or less, 7.7 mm or less, or 7.6 mm or less. Suitably, the positive electrode may have a thickness of 3.5 mm or more, 4.0 mm or more, 4.5 mm or more, 5.0 mm or more, 5.5 mm or more, 6.0 mm or more, 6.5 mm or more, 7.0 mm or more, or 7.5 mm or more. Preferably, the positive electrode may have a thickness of 8.0 mm or less, or from 7.0 to 8.0 mm, for example from 7.5 to 7.7 mm, or about 7.6 mm.

A length of the positive electrode can be chosen to meet a desired battery capacity or form factor and may be defined by the length of the tube members. Suitably, the positive electrode may have a length of at least 100 mm, at least 150 mm, at least 200 mm, at least 250 mm, at least 300 mm, at least 310 mm, at least 320 mm, at least 330 mm, or at least 340 mm; and/or up to 1000 mm, up to 900 mm, up to 800 mm, up to 750 mm, up to 720 mm, up to 700 mm, up to 650 mm, or up to 600 mm.

A width of the positive electrode can be chosen to meet a desired battery capacity or form factor and may be defined by the number of tube members. Suitably, the positive electrode may have a width of at least 150 mm, at least 160 mm, at least 170 mm, at least 173 mm, at least 175 mm, at least 180 mm, or at least 183 mm; and/or up to 250 mm, up to 240 mm, up to 230 mm, up to 220 mm, up to 210 mm, up to 200 mm, up to 190 mm, or up to 185 mm.

The negative electrode comprises a conducting grid and a negative active material in contact with the conducting grid. Such a grid-based electrode may be referred to as a “flat plate” electrode.

The negative active material is typically prepared as a paste, which paste may be cured to form the negative active material. The negative active material comprises carbon nanomaterial, which may be introduced into the paste.

The term “carbon nanomaterial” is used herein to refer to carbon material comprising or consisting of nanoparticles sized, in at least one dimension, in the range of from the thickness of a single graphene layer to about 100 nm.

Such material can help to improve the conductivity and charge acceptance of the negative active material and may also contribute to structural rigidity.

Advantageously, the carbon in the carbon nanomaterial may be sp² hybridised. Suitably, substantially all the caron in the carbon nanomaterial may be sp² hybridised.

Optionally, the carbon nanomaterial may comprise or consist of a graphene sheet. A graphene sheet may be single-layer graphene, bilayer graphene, trilayer graphene, few-layer graphene, or multi-layer graphene material, or combinations thereof.

The term “single-layer graphene” is used herein to refer to a single graphene layer.

The term “bilayer graphene” is used herein to refer to two stacked graphene layers.

The term “trilayer graphene” is used herein to refer three stacked graphene layers.

The term “few-layer graphene” is used herein to refer to 2 to 5 stacked graphene layers.

The term “multi-layer graphene” is used herein to refer to 2 to 10 stacked graphene layers.

Carbon nanomaterial particles as defined herein comprise at least 30 carbon atoms, suitably at least 100 carbon atoms.

Graphene sheets may be pristine or contain impurities. A graphene sheet, or indeed the carbon material as a whole, may be pristine. The term “pristine” is used herein to describe graphene sheets or carbon substantially free from impurities.

Alternatively, a graphene sheet, or indeed the carbon material, may comprise one or more impurities. For example, the sheet or material may be oxidised. Typical impurities are heteroatoms e.g. defined as O, S, N, and P.

Partially oxidised graphene sheets are particularly common and may lead to desirable properties in the carbon material. Suitably, a graphene sheet or indeed the carbon material as a whole, may have a C/O atomic ratio of at least 2, in particular of at least 3, or even of at least 5 or 10. In some embodiments of the invention, the C/O atomic ratio is in the range of from 2 to 10. Pristine graphene layers or carbon material may, for example, have a C/O atomic ratio of at least 20.

Advantageously, the carbon nanomaterial may comprise or consist of carbon nanotubes. Thus, the negative active material may comprise carbon nanotubes.

The term “carbon nanotubes” is used herein to refer to tubes consisting of a sheet of graphene wound into a cylinder. As is known in the art, carbon nanotubes can have a diameter as small as 1 nm. Single wall nanotubes (SWNTs) and multiple wall nanotubes (MWNTs), with many concentric structures, have been synthesized.

Suitably, the carbon nanotubes may have an aspect ratio in the range of from 10 to 500.

Optionally, the carbon nanotubes and an oxidation level in the range of from 1 weight percent to 15 weight percent.

Conveniently, the carbon nanotubes of use in the invention may be open ended.

In an embodiment, the carbon nanotubes may comprise or consist of a plurality of discrete carbon nanotube fibres, optionally as described or defined anywhere in WO2012177869, including in any of the claims thereof.

Preferably, the carbon nanotubes may have a number-based average particle size falling in a range of from 10 nm to 15 nm for the diameter, and from 700 to 900 nm for the length.

Advantageously, substantially all the carbon nanotubes may have a diameter in the range of from 10 nm to 15 nm and a length of from 700 to 900 nm.

The negative active material is typically prepared as a paste, which paste may be cured to form the negative active material. The carbon nanomaterial may be incorporated into the paste.

When preparing the negative active material paste, the carbon nanomaterial may suitably be added to the mixture in the form of a dispersion in water. The dispersion of carbon nanomaterial in water may optionally comprise at least one surfactant or dispersing aid, which may contain a sulfate moiety, for example as described in WO2012177869.

The negative active material paste may, for example, comprise lead (Pb) and lead (II) oxide (PbO). One of the starting materials for an active material paste is known as “grey oxide” or “grey lead oxide”, which is described above.

The grey lead oxide may constitute at least 70 wt % of the negative active material paste, such as for example from 70 wt % to 90 wt %, or from 80 wt % to 85 wt %.

Advantageously the negative active material paste, or the negative active material formed after curing the paste, may comprise the carbon nanomaterial in an amount of from 0.1 wt % to 10 wt %, such as from 0.5 wt % to 5 wt %, from 1 wt % to 2.5 wt %, or about 2 wt %.

In an embodiment, the negative active material paste may comprise lead (Pb), lead monoxide (PbO), sulfuric acid (H₂SO₄), water and carbon nanomaterial.

The negative active material paste may further contain standard additives, including other forms of carbon. Alternatively, the carbon nanomaterial may the sole carbon material in the negative active material.

The components for a negative active material paste may be added to commercial paste mixing machines common in the industry, such as for example a vacuum mixer, to prepare the negative active material paste.

The negative electrode comprises a conducting grid with which the negative active material is in contact. The conducting grid may in principle have any dimension suitable for the battery. However, it has been found that a reduced thickness of the conducting grid, in combination with carbon nanomaterial in the negative active material, can enable enhanced performance, particularly in a battery comprising a positive electrode with tube members. A reduced thickness of the conducting grid can improve utilisation and packing of the negative active material and further reduce electrical resistance at high rates of discharge. This is of particular advantage in the context of a carbon nanomaterial-based negative active material and a performant positive electrode.

In an embodiment, the conducting grid may have a thickness of 4.5 mm or less, 4.0 mm or less, 3.5 mm or less, 3.4 mm or less, 3.3 mm or less, 3.2 mm or less, 3.1 mm or less, 3.0 mm or less, 2.9 mm or less, or 2.8 mm or less. Suitably, the conducting grid may have a thickness of 2.0 mm or more, 2.1 mm or more, 2.2 mm or more, 2.3 mm or more, 2.4 mm or more, 2.5 mm or more, or 2.6 mm or more. Preferably, the conducting grid may have a thickness of 2.8 mm or less, or from 2.6 to 2.8 mm.

The conducting grid may comprise or consist of a suitably conductive and strong material. Conveniently, the conductive grid may be made of the same material as the conductive spines of the tube members. Optionally, the grid may comprise or consist of a lead alloy. The conducting grid may for example be made from such an alloy using gravity casting.

To aid structural strength, particularly in the context of reduced thickness, the lead alloy may advantageously comprise antimony. In some embodiments, the conducting grid comprises or consists of lead antimony alloy having at least 3 wt %, or even at least 4 wt % antimony.

Advantageously, the lead alloy may comprise calcium. Suitably, calcium may be present in the alloy in an amount of at least 0.01 wt %, at least 0.1 wt %, or even at least 0.5 wt %.

Other additives which may be comprised in the lead alloy or lead antimony alloy may for example include tin, aluminium, arsenic, copper, sulfur, selenium, bismuth, iron, manganese, nickel, silver, tellurium, and/or zinc, which for example may each independently be present in amounts of less than 0.5 wt %, or less than 0.3 wt %. Suitably, such additives may be present in an amount of at least 0.01 wt %, at least 0.05 wt %, or even at least 0.1 wt %.

In some embodiments, the lead alloy comprises calcium and tin, optionally in combination with a further additive from the list above.

The conducting grid of the negative electrode is typically connected to a negative group bar, which may be connected to a negative pillar.

To form the negative electrode, the negative active material paste is applied to the conductive grid. The negative active material paste is cured to form the negative active material. An optional drying step may occur before curing. This is a standard process known in the art.

Suitably, the negative electrode may have a thickness of 4.5 mm or less, 4.0 mm or less, 3.5 mm or less, 3.4 mm or less, 3.3 mm or less, 3.2 mm or less, 3.1 mm or less, or 3.0 mm or less. Suitably, the negative electrode may have a thickness of 2.0 mm or more, 2.1 mm or more, 2.2 mm or more, 2.3 mm or more, 2.4 mm or more, 2.5 mm or more, 2.6 mm or more, 2.7 mm or more, 2.8 mm or more, 2.9 mm or more, or 3.0 mm or more.

A length of the negative electrode can be chosen to meet a desired battery capacity or form factor and may be defined by the length of the grid. Suitably, the negative electrode may have a length of at least 100 mm, at least 150 mm, at least 200 mm, at least 250 mm, at least 300 mm, at least 310 mm, at least 320 mm, at least 330 mm, or at least 340 mm;

and/or up to 1000 mm, up to 900 mm, up to 800 mm, up to 750 mm, up to 720 mm, up to 700 mm, up to 650 mm, or up to 600 mm.

A width of the negative electrode can be chosen to meet a desired battery capacity or form factor and may be defined by the width of the grid. Suitably, the positive electrode may have a width of at least 150 mm, at least 160 mm, at least 170 mm, at least 173 mm, at least 175 mm, at least 180 mm, or at least 183 mm; and/or up to 250 mm, up to 240 mm, up to 230 mm, up to 220 mm, up to 210 mm, up to 200 mm, up to 190 mm, or up to 185 mm.

The lead acid battery of the invention comprises at least one positive electrode and at least one negative electrode. A gelled lead acid battery further comprises an electrolyte (also referred to simply as the “electrolyte”), including aqueous sulfuric acid (H₂SO₄) and a gelling agent. The positive and negative electrodes are exposed to the electrolyte.

The concentration of sulfuric acid in the electrolyte is commonly defined in the art by referring to the specific gravity (S.G.) or the (acid) density of the electrolyte.

As is well known in the art, the density can be measured and converted into specific gravity for a given temperature, for example at 20° C. or at 25 °C. In a gelled electrolyte, specific gravity can be calculated via titration.

The value for the density or the specific gravity of the electrolyte in the battery gives insight into the level of charge of the battery. Due to the chemical reactions occurring during charge and discharge of the battery, the density of the sulfuric acid electrolyte (and its specific gravity) decreases during discharging, and increases during charging.

In the lead acid battery of the invention, in an embodiment the electrolyte may have a density of from 1.2 to 1.3 kg l⁻¹@20° C. in the fully charged state, for example from 1.25 to 1.30 kg l⁻¹@20° C., or from 1.29 to 1.30 kg l⁻¹@20 °C. Preferably, the density in the fully charged state is about 1.295 kg l⁻¹@20 °C.

The concentration of the gelling agent in the electrolyte may vary depending on the application and desired properties of the electrolyte.

Advantageously, the gelling agent may be inorganic. Preferably, the gelling agent may comprise or consist of silica. Suitable silicas include fumed silica and colloidal silica.

Fumed silica is an amorphous form of silica formed by the combustion of silicon tetrachloride in hydrogen-oxygen furnaces. An example of a suitable fumed silica suitable as a gelling agent is Aerosil® 200 V.

Suitably, the gelling agent, optionally silica, may be present in the electrolyte in an amount of at least 1 wt %, or at least 3 wt %, or at least 5 wt %, or even at least 10 wt % based on the total weight of the electrolyte. Suitably, the gelling agent, optionally silica, may be present in an amount up to 35 wt %, or up to 30 wt %, or even up to 25 wt % based on the total weight of the electrolyte.

In some embodiments, the gelling agent, optionally silica, is present in an amount in the range of from 1 to 35 wt %, or in the range of from 3 to 30 wt %, or even in the range of from 5 to 25 wt % based on the total weight of the electrolyte.

The electrolyte may comprise other acids or additives.

Advantageously, the electrolyte may comprise phosphoric acid. This can improve cyclability. Suitably, the phosphoric acid may be present in an amount in the range of from 0.1 to 10 wt %, or in the range of from 0.5 to 5 wt %, or even in the range of from 1 to 5 wt % based on the total weight of the electrolyte.

Optionally, the electrolyte may comprise an alkali metal sulphate, for example sodium sulphate. This can help to mitigate against lead dendrites. Suitably, the alkali metal sulphate may be present in an amount in the range of from 0.1 to 5 wt %, or in the range of from 0.5 to 3 wt %, or even in the range of from 1 to 2 wt % based on the total weight of the electrolyte.

The lead acid battery of the invention comprises at least one positive electrode and at least one negative electrode.

In an embodiment, the battery comprises at least n positive electrodes and n+1 negative electrodes, wherein n is an integer. n may, for example, be 1, 2, 3, 4, 5, 6, 7, 8, 9 or 10, 11, 12, 13, 14, 15, 16, 17, 18, 19, or 20. In an embodiment, the battery comprises n positive electrodes and n+1 negative electrodes.

The capacity of the battery can be increased by adding additional electrodes (plates). The number of plates may be adjusted to create the required Ah value for the battery. As is well known in the art, the battery capacity is a measure of the charge stored by the battery, which is commonly expressed in ampere hour (Ah).

The positive and negative electrodes (plates) in the battery may together be referred to as the “plate group”.

In the battery, the electrodes (plates) may be stacked in an alternating order, i.e. negative, positive, negative (etc.).

Preferably, the electrodes at each end of the plate group are negative electrodes. In an embodiment, the negative electrodes in the battery may all be of the same size. Alternatively, the negative electrodes at one or at each end of the plate group may be of a smaller size than the other negative electrode(s) in the battery. Preferably, the positive electrodes in the battery may all be of the same size.

Lead acid batteries commonly comprise separators, which are positioned between the positive and negative electrode plates to separate them. The pores of battery separators should be small enough to prevent lead particles from penetrating and causing short circuits, yet as large as possible minimise electrical resistance and acid displacement.

The lead acid battery may comprise at least one microporous separator. Microporous separators are film, or filament, walled structures having an average pore size in the range of from 5 nm up to 10 μm. Suitably, the microporous separator may have an average pore size in the range of from 0.1 to 5 μm, for example 0.3 to 1 μm.

Advantageously, the separator may have a narrow pore size, with at least percent of all pores within the range of 0.1 μm to 1 μm, or preferably 0.3 μm and 0.8 μm.

Optionally, the separator may have a porosity of at least 60%, preferably at least 70%. Suitably, to aid durability, the separator may have a porosity of at most 85%, preferably at most 80%.

It has been found that separators offering low resistance can help bring to the fore performance gains. Advantageously, the separator may have a resistance of less than 200 mΩ/cm², optionally less than 150 m²/cm², preferably less than 100 m²/cm². Resistances are measured as is known in the art, after 10 minutes boiling in water and 20 minutes soaking in Sulfuric acid (1.280 Sp. Gr.).

In an embodiment, the lead acid battery may comprise at least one phenolic resin separator. Optionally, the separator may comprise a phenol-formaldehyde polymer and a polymeric polyester fleece. Examples of phenolic resin separators include “Darak”® separators produced by Daramic®, Germany. The separators in the battery may be in the form of sleeves around the electrode(s), for example around the positive electrode(s). Alternatively, the separators may be in the form of sheets in between the electrodes. Preferably, the separators may be in the form of sheets in between the electrodes.

The lead acid battery of the present invention may be assembled using processes known in the art. The positive and negative electrodes (plates) may be stacked together in an alternating order, i.e. negative, positive, negative (etc.). Separators may be positioned between the positive and negative electrodes (plates) to ensure there is no physical contact.

The electrodes are combined and connected as is known in the art, e.g. via pillars, lugs and/or terminals.

The negative and positive plates combined (to the required capacity) is known as the “element” of the battery. The element can be placed in a container for the acid solution, for example a polypropylene container.

The dry, unformed batteries are then processed in the formation stage, as is well known in the art. During this stage, the batteries are filled with an aqueous sulfuric acid solution, and individual batteries or batteries connected in series undergo a known charging process with a regulated acid temperature, which may be achieved by circulating the acid solution.

The lead acid battery may preferably be a 2 volt battery, which can also be referred to as a 2 volt cell.

The lead acid battery may preferably comply with European norm EN60254 (part 1 and/or part 2). These norms define the physical dimensions of the battery and the (minimum) electrical performance characteristics.

Optionally, the lead acid battery may have dimensions not exceeding those specified in EN60254 (part 1 and/or part 2).

In various embodiments the battery has dimensions and/or other characteristics as specified in respect of any of the examples in Table 1 or Table 2.

The battery may suitably have a height defined at least in part by the length of the electrodes, a width defined at least in part by the width of its electrodes, and a length defined at least in part by the thickness of the electrodes.

In various embodiments, the battery length divided by the number of positive electrodes in the battery may advantageously be at most about 20 mm, at most about 19 mm, at most about 18 mm, or even at most about 17 mm or at most 16 mm.

This reflects the fact that embodiments of the invention may allow a greater number of electrodes to be incorporated into a battery compared to the prior art.

In an embodiment, the lead acid battery of the invention is an industrial battery, preferably a motive power battery (traction battery). It may be a deep cycling battery.

Advantageously, the battery may be recombinant, i.e. hydrogen and oxygen formed within the battery during charging are recombined to form water. This is facilitated by the presence of gel electrolyte. The presence of calcium in the electrode alloys can further enhance recombination, as can the presence of phosphoric acid and a high porosity, low resistance separator.

Advantageously, the battery may be a sealed lead acid (SLA) battery, or valve-regulated lead-acid (VRLA) battery. Suitably the battery may comprise a housing holding the electrodes and electrolyte, the housing comprising a valve regulated vent plug.

Indeed, another aspect of the invention provides a valve-regulated lead-acid (VRLA) battery comprising at least one positive electrode and at least one negative electrode, wherein the at least one positive electrode includes a plurality of tube members each comprising a tube containing positive active material (PAM) and a conducting spine in contact with the positive active material, and wherein the at least one negative electrode comprises a conducting grid and a negative active material (NAM) in contact with the conducting grid, which negative active material comprises carbon nanomaterial. The positive electrode, negative electrode and optionally other features of the VLRA can be as described hereinabove in respect of other aspects and embodiments. It has been found that a VRLA battery can be made, for example, using a gel electrolyte.

Another aspect of the invention provides a battery assembly comprising more than one lead acid battery according to any aspect or embodiment of the invention. In this context, the battery of the invention may be referred to as a battery cell, a power cell, or simply a cell; these terms may be used interchangeably.

Preferably, the batteries (or cells) in the battery assembly are connected in series. Connecting the batteries in series creates a higher voltage.

In an embodiment, the battery assembly may be contained in frame, which frame may be adapted to receive a fixed number of cells, such as for example 40 cells.

A further aspect of the invention provides the use of a lead acid battery according to any aspect or embodiment of the invention, or a battery assembly according to any aspect or embodiment of the invention of the invention, in a motive power and/or deep cycling application.

In an embodiment, the motive power application is use in a vehicle. More preferably, the vehicle is an industrial vehicle, such as for example a forklift truck.

A deep cycling application comprises deep cycling the battery. Suitably, this may comprise operating the battery over at least 500 cycles at a depth of discharge of at least 25%, or even at least 50% or even at least 70%. In some embodiments, this may comprise operating the battery over at least 1000 cycles at a depth of discharge of at least 25%, or even at least 50% or even at least 70%.

For example, the deep cycling application may comprise operating the battery over at least 500 cycles at a depth of discharge of at least 75%, and/or operating the battery over at least 1000 cycles at a depth of discharge of at least 50%.

Still another aspect of the invention provides a method of making a lead acid battery, the method comprising providing or forming a positive electrode as described in respect of any aspect or embodiment set out herein, providing or forming a negative electrode as described in respect of any aspect or embodiment herein, and incorporating the positive electrode and the negative electrode into a lead acid battery, suitably comprising an electrolyte including a gelling agent.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWING

One or more illustrative implementations not in accordance with the invention, and embodiments of the invention will now be described, by way of example only, with reference to the accompanying drawing, in which:

FIG. 1 is a cutaway perspective view of a flooded lead acid battery not in accordance with the invention, described to illustrate formation and performance of positive and negative electrodes;

FIG. 2 is an exploded view of the battery of FIG. 1; and

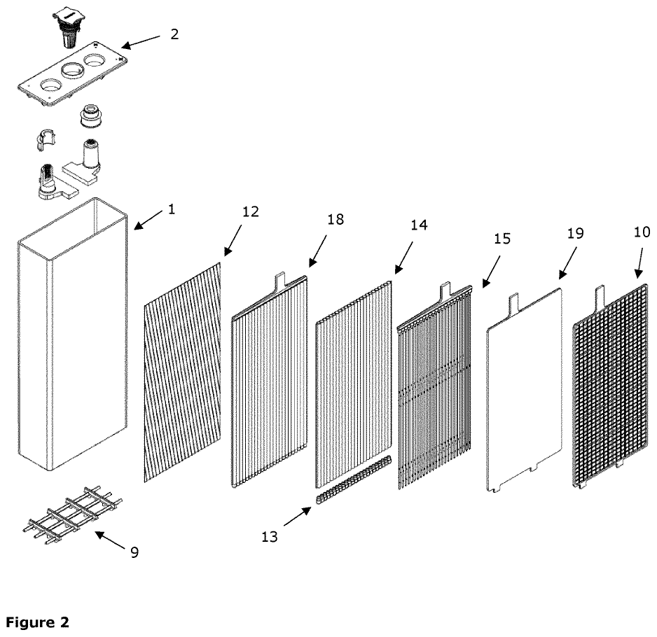

FIG. 3 is a cutaway perspective view of a gelled lead acid battery according to an embodiment of the invention.

### DETAILED DESCRIPTION

Embodiments of batteries in accordance with the invention can be made in different sizes and capacities, for example by adjusting the size of the electrode plates or by adjusting the number of electrode plates present in the battery.

Illustrative flooded and gelled batteries were devised, each employing a combination of a positive electrode comprising tube members and a negative electrode comprising negative active material including carbon nanomaterial.

The flooded batteries do not include a gelling agent in the electrolyte and are therefore not in accordance with the invention. However, they are described herein to illustrate sizing, formation and performance of positive and negative electrodes, as well as performance.

Flooded Batteries—Illustrative, not in Accordance with the Invention

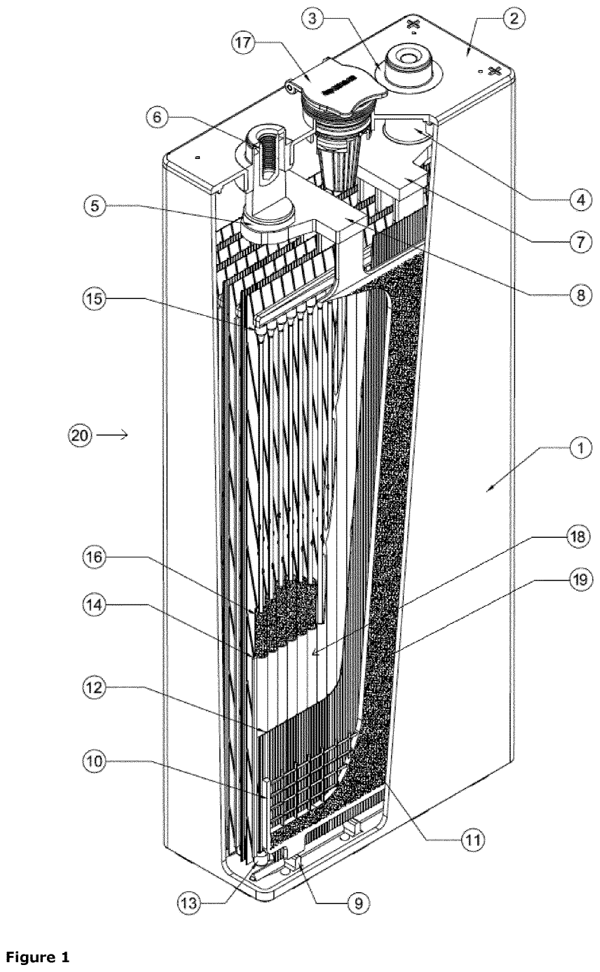

The battery 20 shown in FIG. 1 is a flooded lead acid battery.

The battery 20 contains a housing 1 with a lid 2.

The battery 20 contains positive tubular plates 18. Each positive tubular plate 18 comprises a plurality of conducting spines 15. The spines 15 are embedded in positive active material 16, which is contained within tubes (gauntlet) 14. The far end of each positive tubular plate 18 from the positive group bar 7 is closed with a bottom bar 13.

The battery 20 contains negative plates 19. Each negative plate contains a conducting grid 10, and a negative active material 11 in contact with the conducting grid 10, which has been pasted in the form of a flat plate.

In the battery 20, the positive plates 18 and negative plates 19 are stacked in alternating order. Separators 12 are positioned between the positive and negative plates to separate them. The separators 12 are in the form of sheets.

At the top of the battery 20, a flip-top vent 17 is provided to top-up fluid electrolyte.

At the bottom of the battery 20, the plates 18, 19 are resting on a plate support 9.

The positive tubular plates 18 are connected by a positive group bar 7, which is connected to a positive pillar 4. The negative plates 19 are connected by a negative group bar 8, which is connected to a negative pillar 5. The pillars 4, 5 are positioned through openings in the lid 2 where they pass through grommets 3. Each pillar 4, 5 has a pillar insert 6.

The following general procedure was used to make the battery of FIG. 1.

### Positive Plates

Twenty four conducting spines for the positive tubular plate were manufactured in a high pressure die cast machine and were manufactured from 4.1% lead antimony alloy (Pb—Sb).

The manufactured spines had an elliptical cross section and had two diameters of 2.90×2.60 mm. The spine cut length was 346.50 mm.

The components for the positive active material paste were mixed together in a vacuum mixer to create the positive active material paste. The components were 375 kg of Grey Oxide, 250 kg of Red Lead, 69±5% kg Sulphuric acid S.G. 1.4±0.005 @ 25° C. (kg), and 135±5% kg water. The grey oxide specification was 28 to 32 wt % free lead and 72 to 68 wt % lead monoxide.

The positive spines were fed into a positive gauntlet (made from non-woven polyester, fabric weight 145 g/m²). The positive active material paste was then extruded from filling pipes into the tubes making up the gauntlet. The cavity was completely filled so that the spine was surrounded by active material paste. The bottom of the positive plate was open at this stage. A plastic bottom bar was then ultrasonically welded to the base of the plate to close the bottom of the plate. The plate was washed to remove any excess positive active material paste which may have settled on the outside of the plate during the filling process.

During the curing/drying stage, the positive plate was put in an oven at 80±5° C. for 17 hours and then dried under atmospheric temperature for 10 hours.

The thickness of the produced positive tubular plate was 7.60 mm. This was defined by the thickness of the tube members, which also had a thickness of 7.60 mm.

### Negative Plates

The conducting grid for the negative plate was a gravity cast grid manufactured from 4.1% lead antimony alloy (Pb—Sb), with a thickness of 2.70 mm.

The components for the negative active material paste were mixed together in a vacuum mixer to create the negative active material paste.

The major components were 703 kg grey oxide, 20 negative slurry, 57±5% kg water, 51±5% kg Sulphuric acid S.G. 1.4±0.005 @ 25° C. (kg). The grey oxide specification was 28 to 32 wt % free lead and 72 to 68 wt % lead monoxide.

To this were added conventional additives to aid fluidisation and crystallisation (ca 1.5 kg), barium sulphate (ca 3.5 kg), carbon black (ca 6.3 kg) and fibres (ca 0.6 kg), as well as ca 14.3 kg of carbon nanotubes. The carbon nanotubes were the Pb4100N product manufactured by Molecular Rebar Design, Austin, Texas (supplier Black Diamond Structures, Austin, Texas).

The negative cast grid was fed into a negative pasting line. The negative active material was pushed through a hopper and then pressed/pasted into the negative plate covering all of the voids and cavity within the grid. The negative plate then passed through a flash drier to dry the plates slightly which prevents them from sticking together during the next stage.

During the curing/drying stage, the negative plate was put in an oven at 40° C. for 10 hours, then at 60° C. for 10 hours and then dried under atmospheric temperature for 30 hours.

### Battery Construction

The positive and negative plates are assembled into a lead acid battery in conventional fashion. The electrolyte in this battery is an aqueous acid solution of sulfuric acid (H₂SO₄).

### Performance

To illustrate performance and advantages associated with a combination of a positive electrode comprising tube members and a negative electrode comprising negative active material including carbon nanomaterial, twenty four flooded lead acid batteries (E1 to E24) were constructed in accordance with the general procedure explained with respect to the embodiment of FIG. 1, but with specifications as shown in Table 1. All batteries had a width of 198.0 mm.

The performance of these batteries was compared with twenty four conventional batteries (C1 to C24) having the same form factor but the following significant structural differences:
tubular positive plates with a thickness of 9.65 mm, each with eighteen tube members having a largest diameter of 9.65 mm
flat negative plates made without carbon nanotubes

Furthermore, the conventional batteries had separators formed as sleeves around the positive electrodes and a non-woven polyester gauntlet with a lower fabric weight of about 135 g/m².

On account of these differences, a larger number of plates could be incorporated in E1 to E24 relative to the corresponding comparative examples.

The following key advantages were noted in the exemplified flooded batteries:
Higher Capacity-exemplified embodiments of the invention have between 5-10% more capacity vs the comparative battery in the same footprint. This leads to significantly longer runtimes.
Recharged in half the time compared to the corresponding comparative examples.

The exemplified flooded batteries are highly suited to use in heavy duty applications, e.g. as forklift truck batteries to be worked hard. The comparative batteries would be inferior in this application on a daily basis (may not last for the full shift) and the heavy demands on the battery will cause earlier failure. Also, because the comparative batteries typically take 8-12 hrs to recharge, one forklift truck would require 3 batteries to operate on a 24 hr basis. The exemplified batteries can recharge fully in 4 hours which means only 2 batteries would be required to complete a 24 hr shift.

### Gelled Batteries—Embodiments of Invention

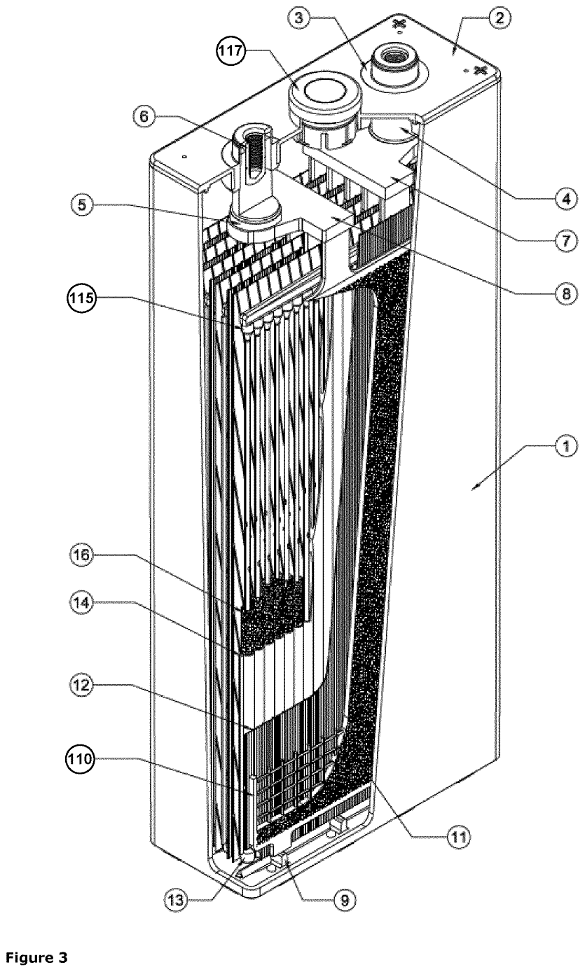

The battery shown in FIG. 3 is a recombinant VLRA gelled lead acid battery in accordance with an embodiment of the invention.

The gelled lead acid battery and its construction is identical to the flooded lead acid battery of FIG. 1, save for the differences discussed hereinbelow (like reference numerals are used for like parts in FIG. 3):
The battery comprises a valve regulated vent plug 117 including a flame arrestor instead of a flip-top vent 17
The conducting spines 115 of the positive tubular plate were manufactured from a lead calcium tin aluminium (Pb—Ca—Sn—Al) alloy instead of a lead antimony alloy (Pb—Sb). Calcium and aluminium were present in an amount less than 0.1 wt %, whereas tin was present in an amount of 0.3 to 0.4 wt %.
The conducting grid 110 of the negative plate was also manufactured from a lead calcium tin (Pb—Ca—Sn—Al) alloy instead of the lead antimony alloy (Pb—Sb). Calcium and aluminium were present in an amount less than 0.2 wt %, whereas tin was present in an amount of 0.2 to 0.3 wt %.
Following a conventional formation process employing an aqueous acid solution of sulfuric acid (H₂SO₄), the acid solution was removed and the battery was filled with an electrolyte comprising aqueous sulphuric acid, phosphoric acid, and densified hydrophilic fumed silica (Aerosil® 200 V) as gelling agent at a concentration of about 6% w/w.

### Performance

Twenty four gelled lead acid batteries (G1 to G24) were constructed in accordance with the general procedure explained with respect to the embodiment of FIG. 3, but with specifications as shown in Table 2.

All batteries had a width of 198.0 mm. As a large head space above the plates is not required for topping up electrolyte, the height dimensions were reduced compared to flooded batteries E1 to E24. As expected, as gel electrolyte isn't as efficient as the flooded equivalent, this leads to a reduction in capacity of approx. 15% even though we have the same amount of active material.

However, the batteries in accordance with FIG. 3 were found to perform well, and offer additional convenience compared to the flooded batteries in accordance with FIG. 1.

The gelled electrolyte permitted vertical as well as horizontal installation. Furthermore, as a recombinant system was achieved, the maintenance burden was significantly reduced (no watering required). There was also a reduction in risk of acid spillage or acidic fumes.

TABLE 1

| Dimensions H1/H2/L | | | | | | |
|---|---|---|---|---|---|---|
| (mm) | Number* | Comp Model* | Plates*^{‡} | Ah/Cell* | Wh/Cell* | Number |
| 463.5/493.5/65 | C1 | 3 PzS-ET 270 | 3p, 4n | 270 | 540 | E1 |
| 463.5/493.5/83 | C2 | 4 PzS-ET 360 | 4p, 5n | 360 | 720 | E2 |
| 463.5/493.5/101 | C3 | 5 PzS-ET 450 | 5p, 6n | 450 | 900 | E3 |
| 463.5/493.5/119 | C4 | 6 PzS-ET 540 | 6p, 7n | 540 | 1080 | E4 |
| 463.5/493.5/137 | C5 | 7 PzS-ET 630 | 7p, 8n | 630 | 1260 | E5 |
| 463.5/493.5/155 | C6 | 8 PzS-ET 720 | 8p, 9n | 720 | 1440 | E6 |
| 463.5/493.5/173 | C7 | 9 PzS-ET 810 | 9p, 10n | 810 | 1620 | E7 |
| 463.5/493.5/191 | C8 | 10 PzS-ET 900 | 10p, 11n | 900 | 1800 | E8 |
| 569.0/599.0/65 | C9 | 3 PzS-ET 375 | 3p, 4n | 375 | 750 | E9 |
| 569.0/599.0/83 | C10 | 4 PzS-ET 500 | 4p, 5n | 500 | 1000 | E10 |
| 569.0/599.0/101 | C11 | 5 PzS-ET 625 | 5p, 6n | 625 | 1250 | E11 |
| 569.0/599.0/119 | C12 | 6 PzS-ET 750 | 6p, 7n | 750 | 1500 | E12 |
| 569.0/599.0/137 | C13 | 7 PzS-ET 875 | 7p, 8n | 875 | 1750 | E13 |
| 569.0/599.0/155 | C14 | 8 PzS-ET 1000 | 8p, 9n | 1000 | 2000 | E14 |
| 569.0/599.0/173 | C15 | 9 PzS-ET 1125 | 9p, 10n | 1125 | 2250 | E15 |
| 569.0/599.0/191 | C16 | 10 PzS-ET 1250 | 10p, 11n | 1250 | 2500 | E16 |
| 713.5/743.5/65 | C17 | 3 PzS-ET 465 | 3p, 4n | 465 | 930 | E17 |
| 713.5/743.5/83 | C18 | 4 PzS-ET 620 | 4p. 5n | 620 | 1240 | E18 |
| 713.5/743.5/101 | C19 | 5 PzS-ET 775 | 5p, 6n | 775 | 1550 | E19 |
| 713.5/743.5/119 | C20 | 6 PzS-ET 930 | 6p, 7n | 930 | 1860 | E20 |
| 713.5/743.5/137 | C21 | 7 PzS-ET 1085 | 7p, 8n | 1085 | 2170 | E21 |
| 713.5/743.5/155 | C22 | 8 PzS-ET 1240 | 8p, 9n | 1240 | 2480 | E22 |
| 713.5/743.5/173 | C23 | 9 PzS-ET 1395 | 9p, 10n | 1395 | 2790 | E23 |
| 713.5/743.5/191 | C24 | 10 PzS-ET 1550 | 10p, 11n | 1550 | 3100 | E24 |

| | | Weight | | | 24 V | 36 V | 48 V | 80 V |
|---|---|---|---|---|---|---|---|---|
| Model | Plates^{‡} | (kg) | Ah/Cell | Wh/Cell | (kWh) | (kWh) | (kWh) | (kWh) |
| QUA600 | 4p, 5n | 17.0 | 300 | 600 | 7.2 | 10.8 | 14.4 | 24.0 |
| QUA800 | 5p, 6n | 21.2 | 400 | 800 | 9.6 | 14.4 | 19.2 | 32.0 |
| QUA1050 | 7p, 8n | 25.4 | 525 | 1050 | 12.6 | 18.9 | 25.2 | 42.0 |
| QUA1200 | 8p, 9n | 29.7 | 600 | 1200 | 14.4 | 21.6 | 28.8 | 48.0 |
| QUA1350 | 9p, 10n | 33.9 | 675 | 1350 | 16.2 | 24.3 | 32.4 | 54.0 |
| QUA1650 | 11p, 12n | 40.4 | 825 | 1650 | 19.8 | 29.7 | 39.6 | 66.0 |
| QUA1800 | 12p, 13n | 44.5 | 900 | 1800 | 21.6 | 32.4 | 43.2 | 72.0 |
| QUA2100 | 13p, 14n | 48.8 | 1050 | 2100 | 25.2 | 37.8 | 50.4 | 84.0 |
| QUA780 | 4p, 5n | 21.8 | 390 | 780 | 9.4 | 14.0 | 18.7 | 31.2 |
| QUA1040 | 5p, 6n | 27.2 | 520 | 1040 | 12.5 | 18.7 | 25.0 | 41.6 |
| QUA1320 | 7p, 8n | 32.6 | 660 | 1320 | 15.8 | 23.8 | 31.7 | 52.8 |
| QUA1560 | 8p, 9n | 38.0 | 780 | 1560 | 18.7 | 28.1 | 37.4 | 62.4 |
| QUA1760 | 9p, 10n | 43.5 | 880 | 1760 | 21.1 | 31.7 | 42.2 | 70.4 |
| QUA2080 | 11p, 12n | 51.9 | 1040 | 2080 | 25.0 | 37.4 | 49.9 | 83.2 |
| QUA2320 | 12p, 13n | 57.3 | 1160 | 2320 | 27.8 | 41.8 | 55.7 | 92.8 |
| QUA2650 | 13p, 14n | 62.7 | 1325 | 2650 | 31.8 | 47.7 | 63.6 | 106.0 |
| QUA990 | 4p, 5n | 27.9 | 495 | 990 | 11.9 | 17.8 | 23.8 | 39.6 |
| QUA1280 | 5p, 6n | 34.8 | 640 | 1280 | 15.4 | 23.0 | 30.7 | 51.2 |
| QUA1680 | 7p, 8n | 41.7 | 840 | 1680 | 20.2 | 30.2 | 40.3 | 67.2 |
| QUA1980 | 8p, 9n | 48.6 | 990 | 1980 | 23.8 | 35.6 | 47.5 | 79.2 |
| QUA2270 | 9p, 10n | 55.5 | 1135 | 2270 | 27.2 | 40.9 | 54.5 | 90.8 |
| QUA2640 | 11p, 12n | 66.1 | 1320 | 2640 | 31.7 | 47.5 | 63.4 | 105.6 |
| QUA2950 | 12p, 13n | 73.1 | 1475 | 2950 | 35.4 | 53.1 | 70.8 | 118.0 |
| QUA3360 | 13p, 14n | 80.1 | 1680 | 3360 | 40.3 | 60.5 | 80.6 | 134.4 |

*= Comparative
H1/H2/L = height over lid/height including connector and bolt/length
^{‡}Plates are indicated as the number of positive plates (p) and negative plates (n)

TABLE 2

| Dimension H1/H2/L | | | | Weight | | | 24 V | 36 V | 48 V | 80 V |
|---|---|---|---|---|---|---|---|---|---|---|
| (mm) | Number | Model | Plates | (kg) | Ah/Cell | Wh/Cell | (kWh) | (kWh) | (kWh) | (kWh) |
| 448.5/478.5/65 | G1 | QUAV540 | 4p, 5n | 17.0 | 270 | 540 | 6.48 | 9.72 | 12.96 | 21.6 |
| 448.5/478.5/83 | G2 | QUAV720 | 5p, 6n | 21.2 | 360 | 720 | 8.64 | 12.96 | 17.28 | 28.8 |
| 448.5/478.5/101 | G3 | QUAV950 | 7p, 8n | 25.4 | 475 | 950 | 11.4 | 17.10 | 22.80 | 38.0 |
| 448.5/478.5/119 | G4 | QUAV1080 | 8p, 9n | 29.7 | 540 | 1080 | 12.96 | 19.44 | 25.92 | 43.2 |
| 448.5/478.5/137 | G5 | QUAV1220 | 9p, 10n | 33.9 | 610 | 1220 | 14.64 | 21.96 | 29.28 | 48.8 |
| 448.5/478.5/155 | G6 | QUAV1480 | 11p, 12n | 40.4 | 740 | 1480 | 17.76 | 26.64 | 35.52 | 59.2 |
| 448.5/478.5/173 | G7 | QUAV1620 | 12p, 13n | 44.5 | 810 | 1620 | 19.44 | 29.16 | 38.88 | 64.8 |
| 448.5/478.5/191 | G8 | QUAV1890 | 13p, 14n | 48.8 | 945 | 1890 | 22.68 | 34.02 | 45.36 | 75.6 |
| 554.0/584.0/65 | G9 | QUAV700 | 4p, 5n | 21.8 | 350 | 700 | 8.40 | 12.60 | 16.80 | 28.0 |
| 554.0/584.0/83 | G10 | QUAV930 | 5p, 6n | 27.2 | 465 | 930 | 11.16 | 16.74 | 22.32 | 37.2 |
| 554.0/584.0/101 | G11 | QUAV1190 | 7p, 8n | 32.6 | 595 | 1190 | 14.28 | 21.42 | 28.56 | 47.6 |
| 554.0/584.0/119 | G12 | QUAV1400 | 8p, 9n | 38.0 | 700 | 1400 | 16.80 | 25.20 | 33.60 | 56.0 |
| 554.0/584.0/137 | G13 | QUAV1580 | 9p, 10n | 43.5 | 790 | 1580 | 18.96 | 28.44 | 37.92 | 63.2 |
| 554.0/584.0/155 | G14 | QUAV1870 | 11p, 12n | 51.9 | 935 | 1870 | 22.44 | 33.66 | 44.88 | 74.8 |
| 554.0/584.0/173 | G15 | QUAV2090 | 12p, 13n | 57.3 | 1045 | 2090 | 25.08 | 37.62 | 50.16 | 83.6 |
| 554.0/584.0/191 | G16 | QUAV2390 | 13p, 14n | 62.7 | 1195 | 2390 | 28.68 | 43.02 | 57.36 | 95.6 |
| 686.5/716.5/65 | G17 | QUAV890 | 4p, 5n | 27.9 | 445 | 890 | 10.68 | 16.02 | 21.36 | 35.6 |
| 686.5/716.5/83 | G18 | QUAV1150 | 5p, 6n | 34.8 | 575 | 1150 | 13.80 | 20.70 | 27.60 | 46.0 |
| 686.5/716.5/101 | G19 | QUAV1510 | 7p, 8n | 41.7 | 755 | 1510 | 18.12 | 27.18 | 36.24 | 60.4 |
| 686.5/716.5/119 | G20 | QUAV1780 | 8p, 9n | 48.6 | 890 | 1780 | 21.36 | 32.04 | 42.72 | 71.2 |
| 686.5/716.5/137 | G21 | QUAV2040 | 9p, 10n | 55.5 | 1020 | 2040 | 24.48 | 36.72 | 48.96 | 81.6 |
| 686.5/716.5/155 | G22 | QUAV2370 | 11p, 12n | 66.1 | 1185 | 2370 | 28.44 | 42.66 | 56.88 | 94.8 |
| 686.5/716.5/173 | G23 | QUAV2650 | 12p, 13n | 73.1 | 1325 | 2650 | 31.80 | 47.70 | 63.60 | 106.0 |
| 686.5/716.5/191 | G24 | QUAV3020 | 13p, 14n | 80.1 | 1510 | 3020 | 36.24 | 54.36 | 72.48 | 120.8 |

1. A gelled lead acid battery comprising at least one positive electrode, at least one negative electrode and an electrolyte comprising a gelling agent,
wherein the at least one positive electrode includes a plurality of tube members each comprising a tube containing positive active material (PAM) and a conducting spine in contact with the positive active material wherein the conducting spines of the tube members have a cross section with a largest diameter of 3.5 mm or less and the positive electrode has a thickness of 9.5 mm or less,
wherein the at least one negative electrode comprises a conducting grid and a negative active material (NAM) in contact with the conducting grid, which negative active material comprises carbon nanomaterial, and
wherein the battery comprises at least n positive electrodes and n+1 negative electrodes, wherein n is an integer.

2. The lead acid battery of claim 1, wherein the conducting spines each have a cross section with a largest diameter of 3.0 mm or less, and/or the conducting spines each have a cross section with a largest diameter of 2.0 mm or more, optionally wherein the conducting spines each have a cross section with a largest diameter of 2.8 to 3.0 mm.

3-4. (canceled)

5. The lead acid battery of claim 1, wherein the conducting spines have an elliptical cross section.

6. The lead acid battery of claim 5, wherein the conducting spines have a smallest diameter across the smallest part of the elliptical cross section of 2.7 mm or less, and/or the conducting spines have a smallest diameter across the smallest part of the elliptical cross section of 2.0 mm or more, optionally wherein conducting spines have a smallest diameter of from 2.5 to 2.7 mm.

7-8. (canceled)

9. The lead acid battery of claim 1, wherein the tubes containing the positive active material comprise a fibrous non-woven material with a fabric weight greater than 135 g/m².

10. The lead acid battery of claim 1, wherein the thickness of the positive electrode is defined by a thickness of the tube members.

11. The lead acid battery of claim 1, wherein the positive electrode has a thickness of 8.5 mm or less, optionally wherein the positive electrode has a thickness of 8.0 mm or less.

12. (canceled)

13. The lead acid battery of claim 1, wherein the carbon nanomaterial comprises carbon nanotubes.

14. The lead acid battery of claim 1, wherein the negative active material comprises the carbon nanomaterial in an amount of from 0.1 wt % to 10 wt %.

15. The lead acid battery of claim 1, wherein the negative electrode has a thickness of 4.5 mm or less.

16. The lead acid battery of claim 1, comprising a phenolic resin separator.

17. The lead acid battery of claim 1, comprising a separator with a porosity of at least 60%.

18. The lead acid battery of claim 1, comprising a separator with a porosity of at most 80%.

19. The lead acid battery of claim 1, wherein the gelling agent comprises silica, optionally fumed silica.

20. The lead acid battery of claim 1, comprising a separator with a resistance of less than 150 mΩ/cm² (as measured after 10 minutes boiling in water and 20 minutes soaking in Sulfuric acid (1.280 Sp. Gr.)).

21. The lead acid battery of claim 1, which is a motive power battery.

22. The lead acid battery of claim 1, which is a recombinant VRLA battery.

23. A battery assembly comprising more than one gelled lead acid battery of claim 1.

24. The battery assembly of claim 23, wherein the batteries in the battery assembly are connected in series.

25. Use of a gelled lead acid battery of claim 1, or a battery assembly of claim 23, in a motive power application or a deep cycling application.
